(19) United States
(12) Patent Application Publication
(10) Pub. No.: US 2018/0035189 A1
(43) Pub. Date: Feb. 1, 2018

(54) HEADBANDS WITH BUILT-IN MUSIC SYSTEM AND METHODS OF MAKING AND USING THE SAME

(71) Applicant: Drendle LLC dba HeadNoise, Jonesboro, GA (US)

(72) Inventors: Micah Givens, Jonesboro, GA (US); Marcos Zacarias Nve-Nsi, Dunwoody, GA (US)

(21) Appl. No.: 15/663,529

(22) Filed: Jul. 28, 2017

Related U.S. Application Data
(60) Provisional application No. 62/368,458, filed on Jul. 29, 2016.

(51) Int. Cl. H04R 1/02; A41D 20/00; H04R 3/00; A41D 1/00

(52) U.S. Cl. CPC H04R 1/028; A41D 1/002; A41D 20/00; H04R 3/00; H04R 1/025; H04R 2420/09; H04R 2420/07; H04R 2201/028

(57) ABSTRACT

Headbands with built-in music system are disclosed. Methods of making headbands with built-in music system, and methods of using headbands with built-in music system are also disclosed.

### CROSS-REFERENCE TO RELATED APPLICATIONS

This patent application claims the benefit of priority to U.S. Provisional Patent Application Ser. No. 62/368,458 filed on Jul. 29, 2016 and entitled “HEADBANDS WITH BUILT-IN MUSIC SYSTEM AND METHODS OF MAKING AND USING THE SAME,” the subject matter of which is hereby incorporated by reference in its entirety.

### FIELD OF THE INVENTION

The present invention relates to headbands. The present invention also relates to methods of making headbands and methods of using headbands.

### BACKGROUND OF THE INVENTION

Efforts continue to further develop devices for listening to music and fitness tracking.

### SUMMARY OF THE INVENTION

The present invention addresses some of the difficulties and problems discussed above by the discovery of new headbands that enable hands-free, wireless enjoyment of music. The headbands are wireless so as to allow the wearer to be able to listen to music without covering the ears. This allows the user to listen to music while being completely aware of surroundings during outdoor activities. The use of bone conduction makes it so that only the person wearing the headband can hear music generated within the headband. The headbands provide a solution to a user that wants to be active, safe, and listen to music all at the same time.

Accordingly, in one exemplary embodiment, the present invention is directed to headbands. In some exemplary embodiments, the headband comprises a tubular headband material having an outer headband surface, an inner headband surface, and opposite edges between said outer headband surface and said inner headband surface; and one or more signal-accepting components incorporated in or attached to said tubular headband material, said one or more signal-accepting components being capable of receiving a wireless signal from a music-generating device (e.g., a phone, smart phone, tablet, laptop computer, desktop computer, ipod-type device, stereo system, etc.) and converting the wireless signal into music.

The present invention is even further directed to methods of making headbands. In some exemplary embodiments, the method of making a headband comprises incorporating in or attaching to the tubular headband material (described herein) the one or more signal-accepting components (described herein).

The present invention is even further directed to a method of using headbands. In one exemplary embodiment, the method of using a headband comprises: positioning the headband onto a user's head; and listening to music from the headband.

These and other features and advantages of the present invention will become apparent after a review of the following detailed description of the disclosed embodiments and the appended claims.

### BRIEF DESCRIPTION OF THE FIGURES

FIGS. 1A-1D depict various views of one or more exemplary components that may be used in the headbands of the present invention;

FIGS. 2A-2D depict various views of an exemplary headband of the present invention;

FIG. 3 depicts a frontal perspective view of exemplary music-generating components suitable for use in exemplary headband shown in FIGS. 2A-2D;

FIG. 4 depicts a rear view of the exemplary music-generating components shown in FIG. 3;

FIG. 5 depicts a frontal view of exemplary headband support member and components attached thereto suitable for use in exemplary headband shown in FIGS. 2A-2D;

FIG. 6 depicts a rear view of the exemplary headband support member shown in FIG. 5;

FIG. 7 depicts a frontal view of the exemplary headband support member shown in FIG. 5 with a housing member door removed;

FIG. 8 depicts a rear view of the exemplary headband support member shown in FIG. 7;

FIG. 9 depicts a close-up frontal view of the exemplary headband support member shown in FIG. 5 with a housing member door removed;

FIG. 10 depicts a frontal perspective view of another exemplary headband of the present invention;

FIG. 11 depicts a rear perspective view of another exemplary headband of the present invention;

FIG. 12 depicts a frontal perspective view of another exemplary headband of the present invention;

FIG. 13 depicts a rear perspective view of the exemplary headband shown in FIG. 12; and

FIG. 14 depicts an exemplary circuit board suitable for use in the headband of the present invention.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to headbands. The present invention is further directed to methods of making headbands. The present invention is even further directed to methods of using headbands.

The headbands of the present invention and methods of making and using headbands of the present invention are further described in the embodiments below.

### Headband Embodiments

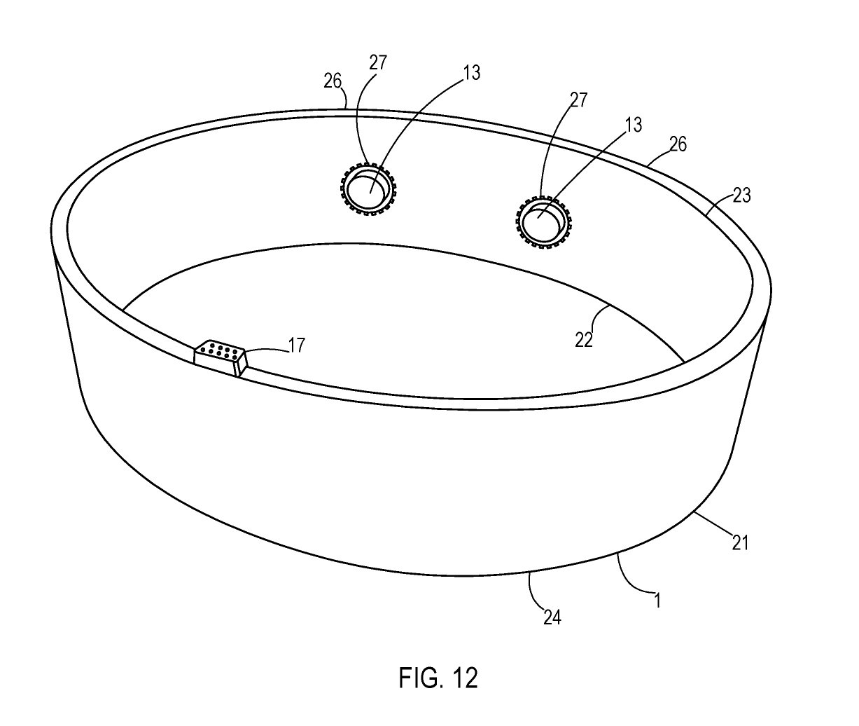

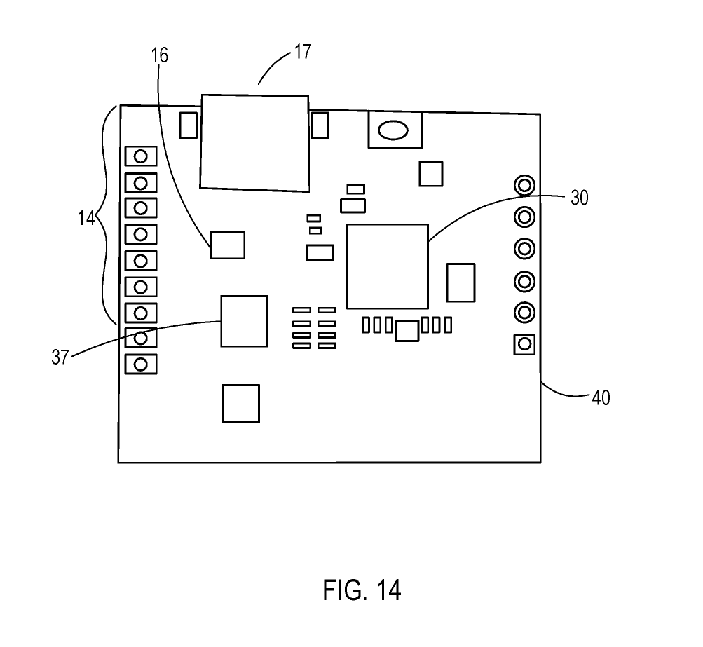

1. A headband 1 comprising: a tubular headband material 20 having an outer headband surface 21, an inner headband surface 22, and opposite edges 23,24 between said outer headband surface 21 and said inner headband surface 22; and one or more signal-accepting components 30 incorporated in or attached to said tubular headband material 20, said one or more signal-accepting components 30 being capable of receiving a wireless signal from a music-generating device (e.g., a phone, smart phone, tablet, laptop computer, desktop computer, ipod-type device, stereo system, etc.) and converting the wireless signal into music.
2. The headband 1 of embodiment 1, wherein said one or more signal-accepting components 30 comprises a Bluetooth device 30. It should be noted that any version of Bluetooth technology may be used in the present invention (e.g., v2.0, v4.2, v5, etc.).
3. The headband 1 of embodiment 1 or 2, wherein said one or more signal-accepting components 30 comprises a Bluetooth device 30, said Bluetooth device 30 comprising Bluetooth v4.2 or v5 technology.
4. The headband 1 of any one of embodiments 1 to 3, further comprising two or more transducers 13 connected to said one or more signal-accepting components 30.
5. The headband 1 of any one of embodiments 1 to 4, further comprising circuitry 14 for processing said wireless signal. Circuitry 14 may comprise any known circuitry for transmitting an electrical signal.
6. The headband 1 of any one of embodiments 1 to 4, further comprising an amplifier 16.
7. The headband 1 of any one of embodiments 1 to 6, further comprising a headband support member 12 that provides support for two or more transducers 13, said one or more signal-accepting components 30, and other components discussed herein.
8. The headband 1 of embodiment 7, further comprising a housing member 19 positioned along headband support member 12, said housing member 19 being sized to house at least a portion of said one or more signal-accepting components 30, and other components discussed herein.
9. The headband 1 of embodiment 8, further comprising a housing member door 18 that is removable from said housing member 19 so as to provide access to one or more signal-accepting components 30, and other components discussed herein, positioned within said housing member 19.
10. The headband 1 of any one of embodiments 1 to 9, further comprising a rechargeable battery 15.
11. The headband 1 of any embodiment 10, wherein said rechargeable battery 15 is positioned within said housing member 19.
12. The headband 1 of any one of embodiments 1 to 11, further comprising a charging port 17. In some embodiments, one or more signal-accepting components 30 (e.g., a Bluetooth device 30), circuitry 14, amplifier 16 and charging port 17 are all positioned on the same circuit board. See, for example, exemplary circuit board 40 shown in FIG. 14. As shown in FIG. 14, exemplary circuit board 40 comprises Bluetooth device 30, circuitry 14 extending all over circuit board 40, amplifier 16, charging port 17, and accelerometer 37 all positioned on exemplary circuit board 40.
13. The headband 1 of any embodiment 12, wherein said charging port 17 is positioned along an outer surface 191 of said housing member 19.
14. The headband 1 of any embodiment 12 or 13, wherein said charging port 17 is positioned along an upper outer surface 192 of said housing member 19.
15. The headband 1 of any one of embodiments 1 to 14, further comprising an on/off switch 11.
16. The headband 1 of any embodiment 15, wherein said on/off switch 11 is positioned along an outer surface 191 of said housing member 19.
17. The headband 1 of embodiment 15 or 16, wherein said on/off switch 11 is positioned along said housing member door 18 of said housing member 19.
18. The headband 1 of any one of embodiments 1 to 17, further comprising one or more electrically conductive wires 4 connecting two or more components to one another.
19. The headband 1 of embodiment 18, wherein said one or more electrically conductive wires 4 connect said two or more transducers 13 to one of more components within said housing member 19.
20. The headband 1 of any one of embodiments 7 to 19, wherein said headband support member 12 comprises a rigid polymeric material.
21. The headband 1 of any one of embodiments 7 to 19, wherein said headband support member 12 comprises an elastic material.
22. The headband 1 of any one of embodiments 7 to 19 and 21, wherein said headband support member 12 comprises an elastic fabric material.
23. The headband 1 of any one of embodiments 7 to 19 and 21, wherein said headband support member 12 comprises an elastic polymeric (e.g., polyester) fabric material.
24. The headband 1 of any one of embodiments 1 to 23, wherein said one or more signal-accepting components 30 are attached to said inner headband surface 22 of said tubular headband material 20.
25. The headband 1 of any one of embodiments 1 to 23, wherein said one or more signal-accepting components 30 are incorporated within said tubular headband material 20.
26. The headband 1 of any one of embodiments 1 to 23 and 25, wherein said tubular headband material 20 further comprises a slit 6 within said inner headband surface 22 or said outer headband surface 21 of said tubular headband material 20, said slit 6 being sized so that said one or more signal-accepting components 30 can be inserted within and removed from said slit 6. In other embodiments, said tubular headband material 20 further comprises a rectangular opening (not shown) within said inner headband surface 22 or said outer headband surface 21 of said tubular headband material 20, said rectangular opening being sized so that said one or more signal-accepting components 30 can be inserted within and removed from said rectangular opening.
27. The headband 1 of embodiment 26, wherein said slit 6 is sized so that said headband support member 12 can be inserted within and removed from said slit 6.
28. The headband 1 of embodiment 26 or 27, wherein said slit 6 is within said inner headband surface 22 of said tubular headband material 20.
29. The headband 1 of any one of embodiments 26 to 28, wherein said slit 6 is within said inner headband surface 22 and extends vertically between opposite edges 23,24.
30. The headband 1 of any one of embodiments 1 to 29, wherein said tubular headband material 20 further comprises two or more openings 26 within said inner headband surface 22 of said tubular headband material 20, each opening 26 being sized so that a given transducer 13 can be positioned within and removed from said opening 26. See, for example, two openings 26 within inner headband surface 22 of exemplary tubular headband material 20 shown in FIG. 12.
31. The headband 1 of any one of embodiments 1 to 29, further comprising one or more clamping members 27 so fixing in place said two or more transducers 13 along said tubular headband material 20. See, for example, two clamping members 27 of exemplary headband 1 shown in FIG. 12.
32. The headband 1 of any one of embodiments 1 to 31, wherein said tubular headband material 20 comprises an elastic material.
33. The headband 1 of any one of embodiments 1 to 32, wherein said tubular headband material 20 comprises an elastic fabric material.
34. The headband 1 of any one of embodiments 1 to 33, wherein said tubular headband material 20 comprises an elastic polymeric (e.g., polyester) fabric material.
35. The headband 1 of any one of embodiments 1 to 34, wherein said tubular headband material 20 comprises cellulosic (e.g., cotton) fabric material.
36. The headband 1 of any one of embodiments 1 to 35, wherein said tubular headband material 20 is in the form of a continuous loop of material.
37. The headband 1 of any one of embodiments 1 to 36, wherein said tubular headband material 20 is separable from said one or more signal-accepting components 30, and machine-washable.
38. The headband 1 of any one of embodiments 1 to 37, wherein said tubular headband material 20 has an overall height H of from about 1.0 in to about 6.0 in (or any value therebetween, in increments of 0.1 inch, for example, 3.4 in, or any range of values therebetween, in increments of 0.1 inch, for example, from 1.5 in to 3.2 in).
39. The headband 1 of any one of embodiments 1 to 38, wherein said tubular headband material 20 has an overall length L (extending along either edge 23,24) of from about 4.0 in to about 18.0 in (or any value therebetween, in increments of 0.1 inch, for example, 13.4 in, or any range of values therebetween, in increments of 0.1 inch, for example, from 12.5 in to 16.2 in).

### Methods of Making Headbands Embodiments

40. A method of making the headband 1 of any one of embodiments 1 to 39, said method comprising: incorporating in or attaching to the tubular headband material 20 the one or more signal-accepting components 30.
41. The method of embodiment 40, said method further comprising: forming the headband support member 12; and attaching the one or more signal-accepting components 30, directly or indirectly, to the headband support member 12.
42. The method of embodiment 41, wherein said forming step is a molding step.
43. The method of any one of embodiments 40 to 42, said method further comprising: forming a slit 6 within the tubular headband material 20.
44. The method of any one of embodiments 40 to 43, said method further comprising: forming two or more openings 27 within the inner headband surface 22 of the tubular headband material 20.

### Methods of Using Headbands Embodiments

45. A method of using the headband 1 of any one of embodiments 1 to 39, said method comprising: positioning the headband 1 onto a user's head; and listening to music from the headband 1.
46. The method of embodiment 45, said method further comprising: separating the tubular headband material 20 from the one or more signal-accepting components 30; and washing the tubular headband material 20.
47. The method of embodiment 46, said method further comprising: reconnecting the tubular headband material 20 and the one or more signal-accepting components 30 after said washing step.
48. The method of any one of embodiments 45 to 47, said method further comprising: inserting the headband support member 12 within the slit 6 of the tubular headband material 20.
49. The method of any one of embodiments 45 to 48, said method further comprising: cutting on the headband 1 via on/off switch 11.
50. The method of any one of embodiments 45 to 49, said method further comprising: cutting off the headband 1 via on/off switch 11.
51. The method of any one of embodiments 45 to 50, said method further comprising: synching the headband 1 with a music-generating device (e.g., a phone, smart phone, tablet, laptop computer, desktop computer, ipod-type device, stereo system, etc.).
52. The method of any one of embodiments 45 to 50, said method further comprising: tracking fitness parameters and/or detecting other properties of a user via one or more biometric sensors (not shown) positioned along headband 1.
53. The method of embodiment 52, wherein the one or more biometric sensors (not shown) are positioned along (1) the inner headband surface 22; (2) an inner surface of headband support member 12, (3) housing member door 18, (4) an inner surface of housing member 19, or (5) any combination of (1) to (4).

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

### Preparation of Exemplary Headbands

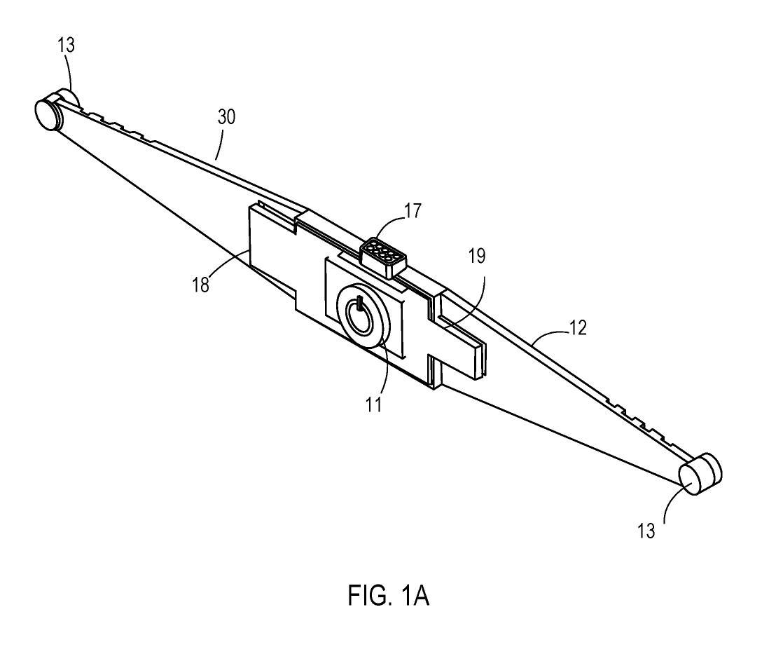

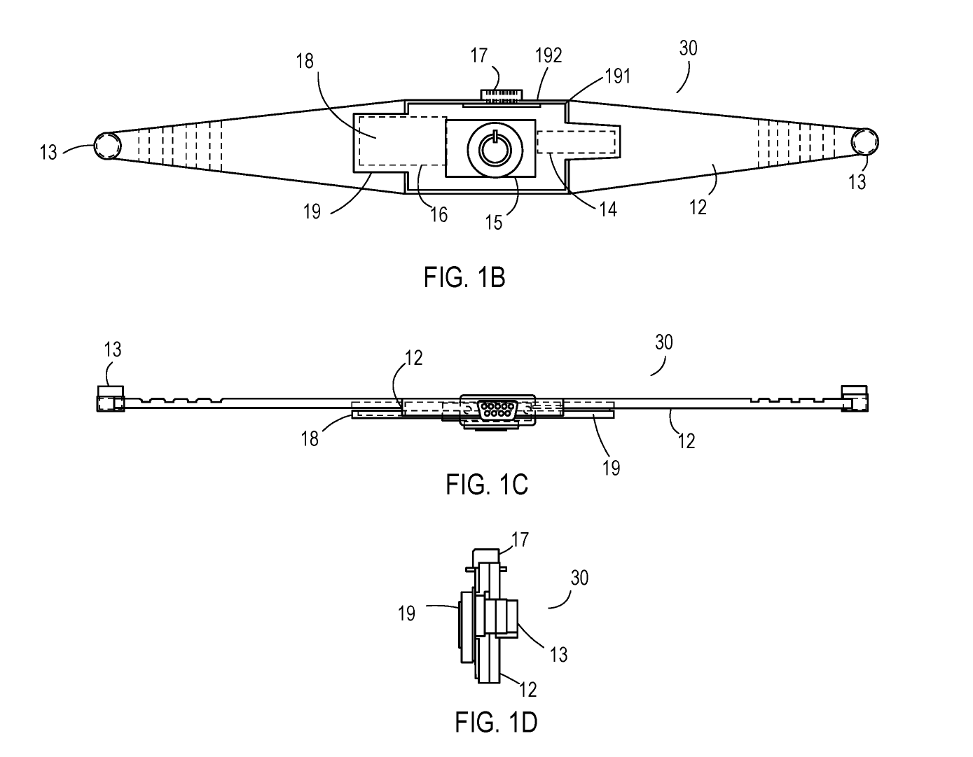

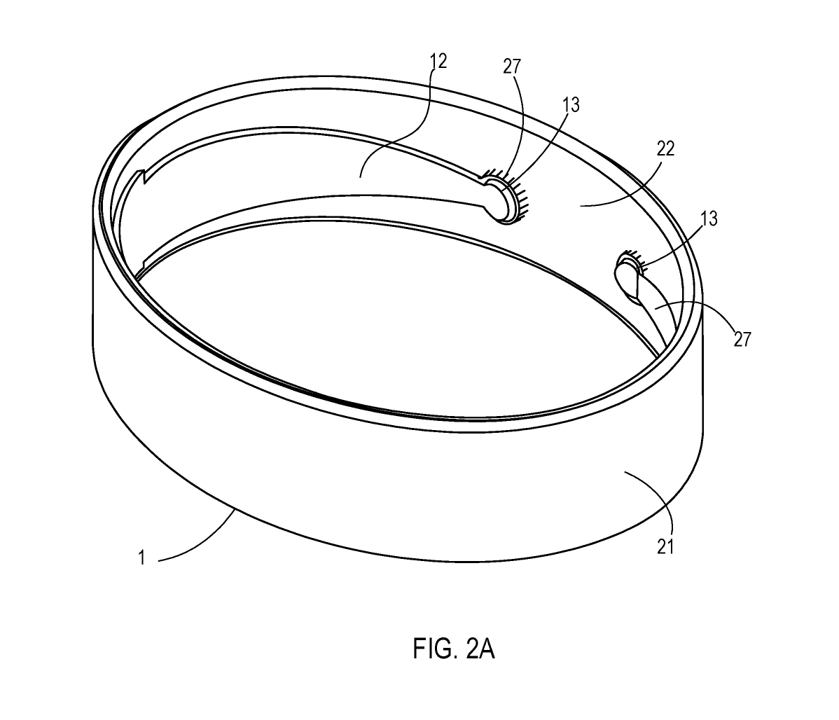

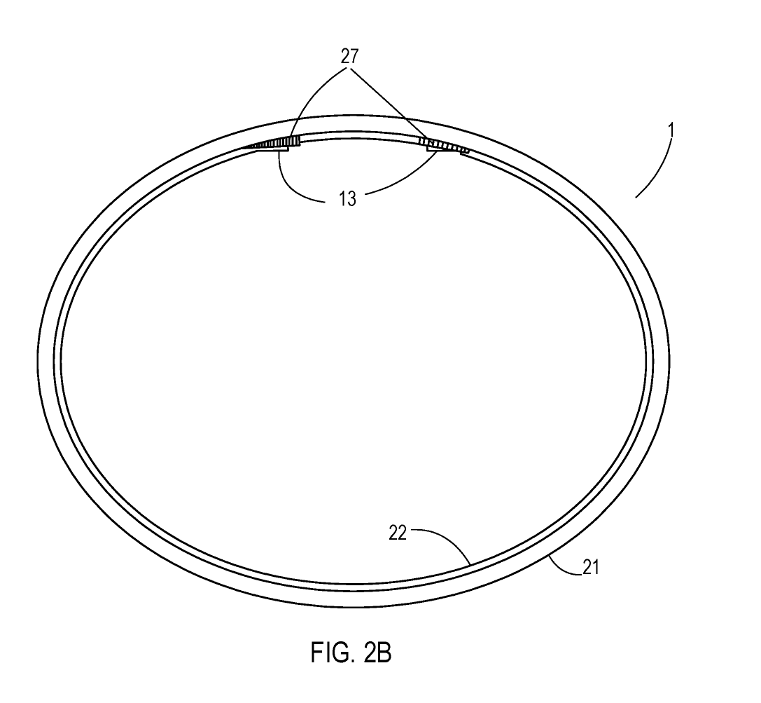

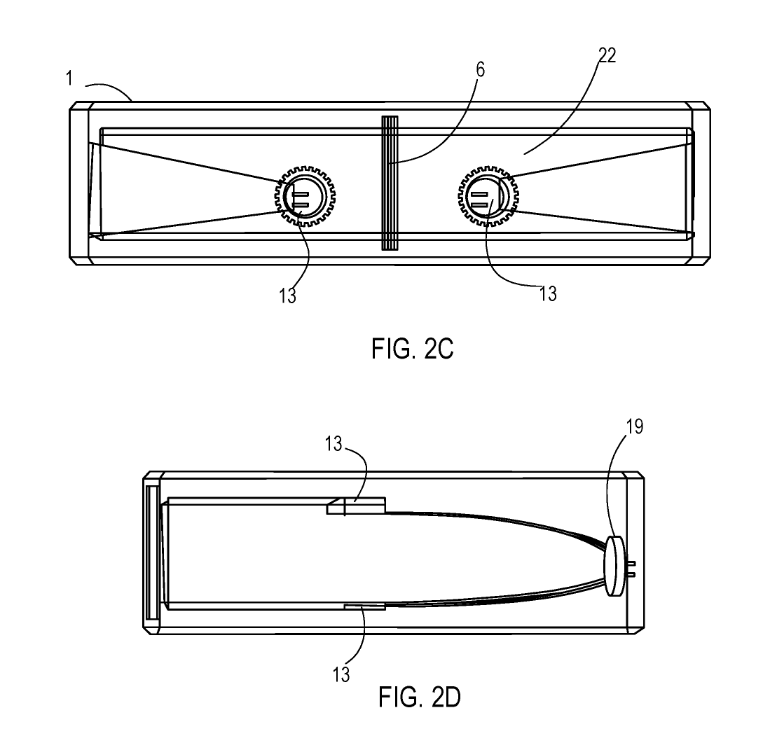

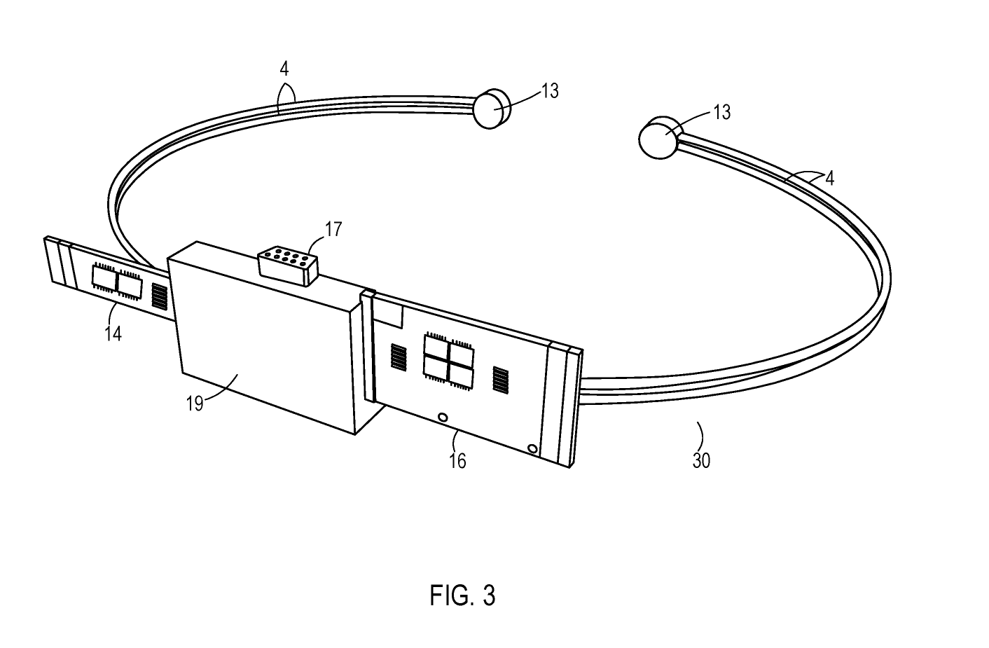

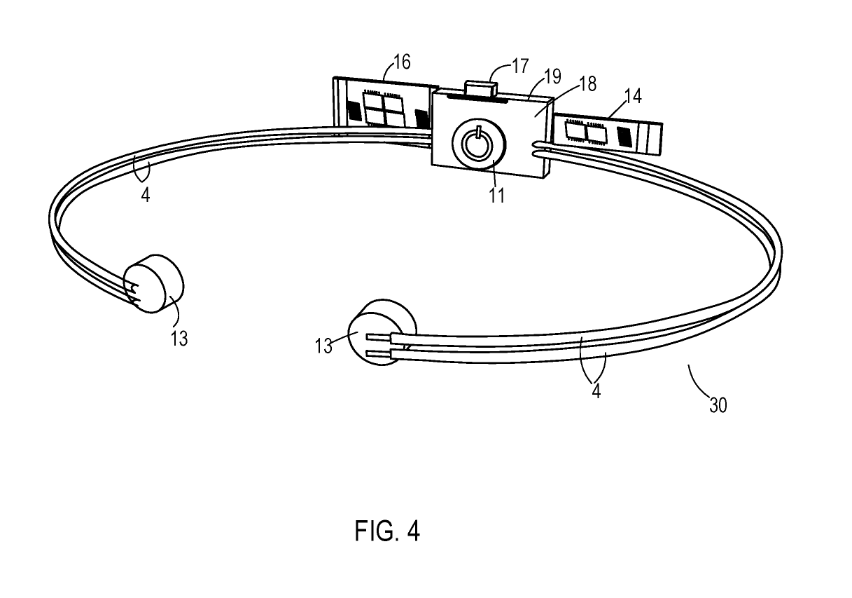

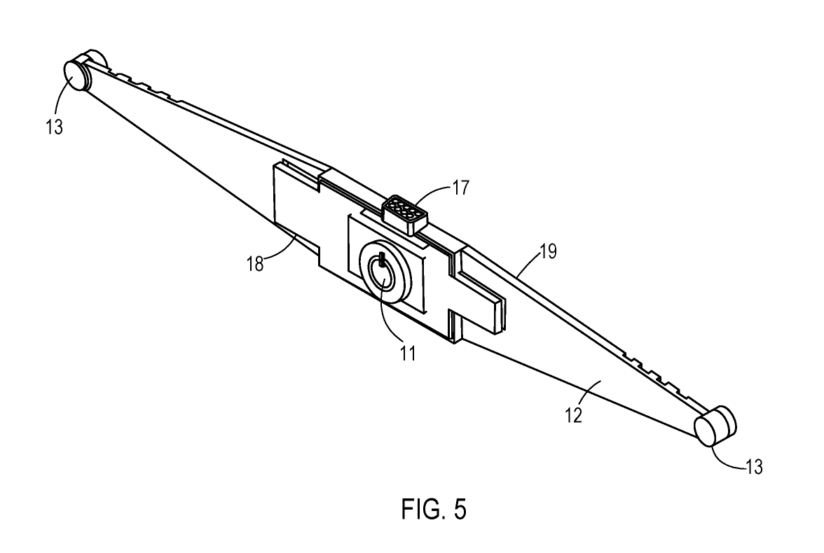

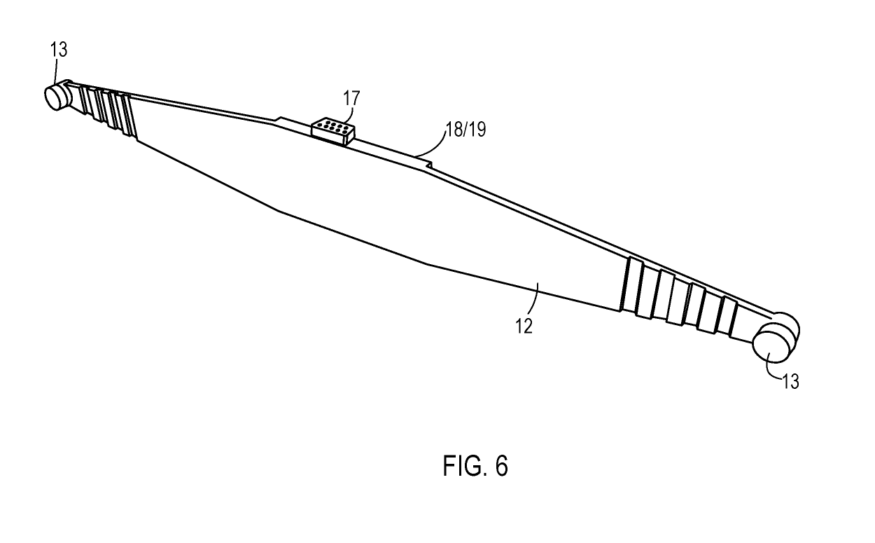

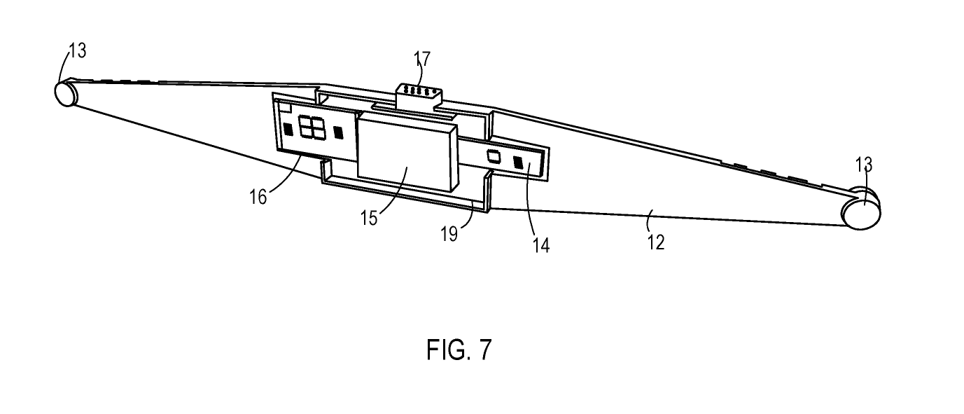

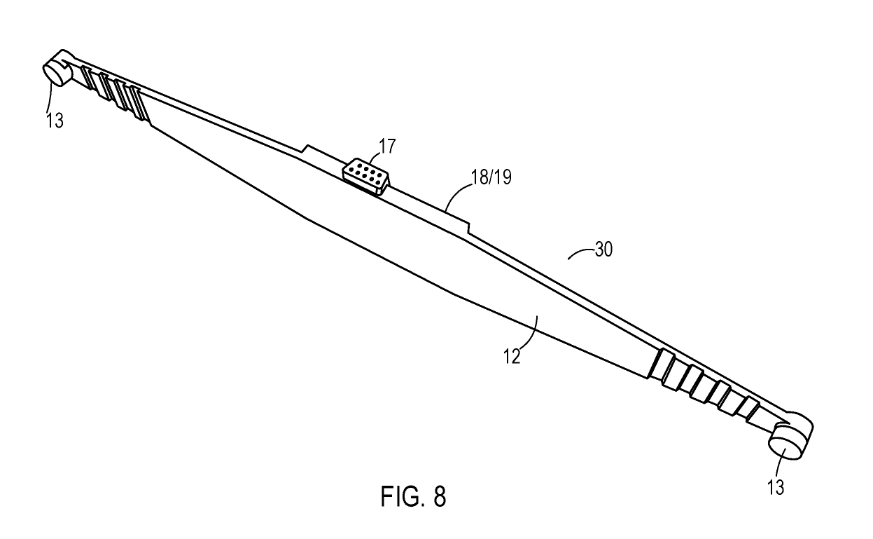

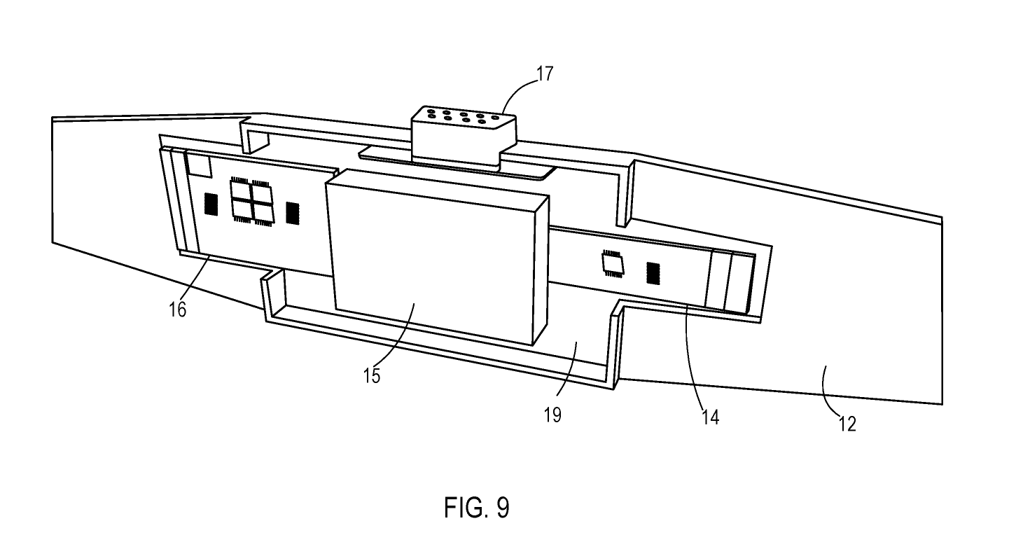

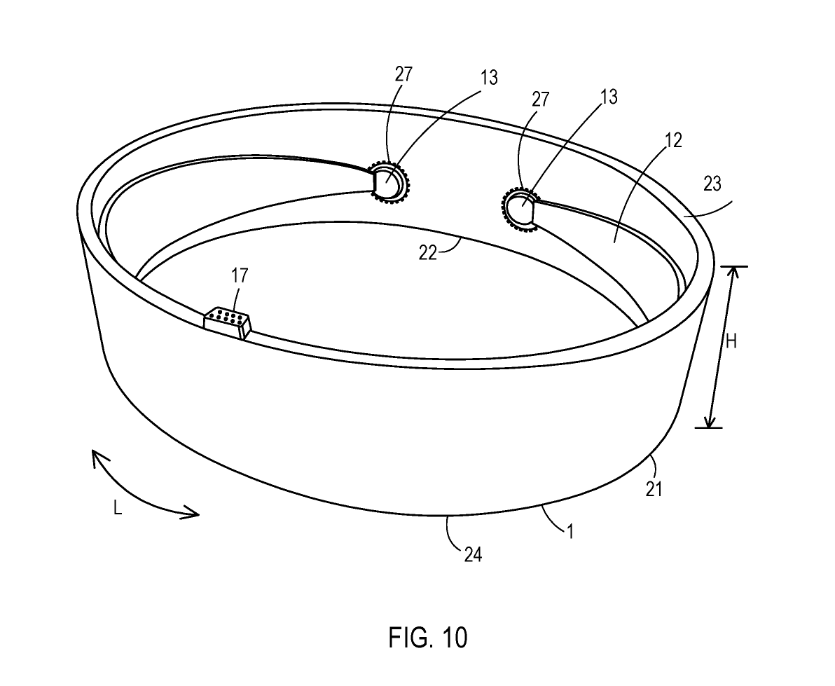

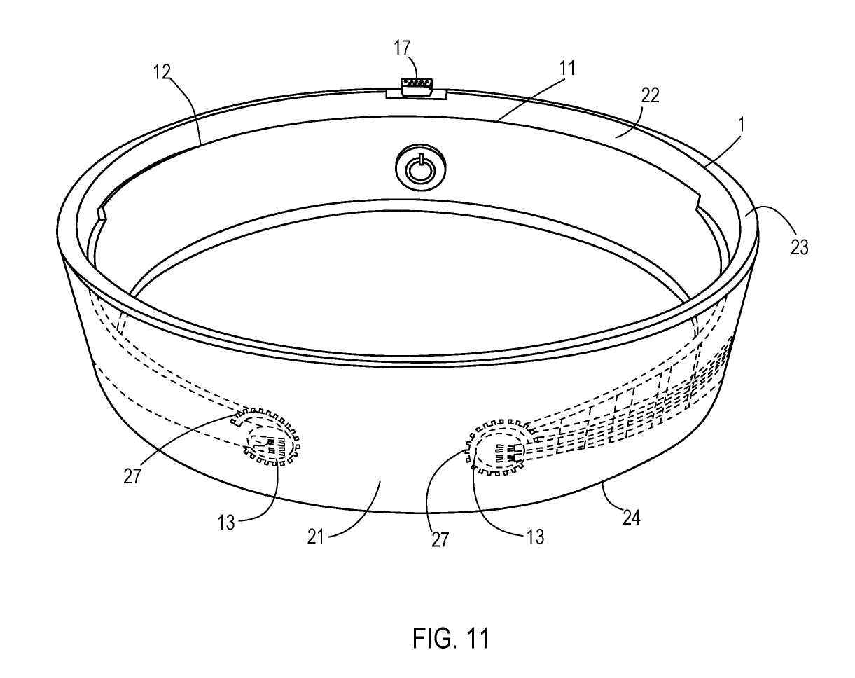

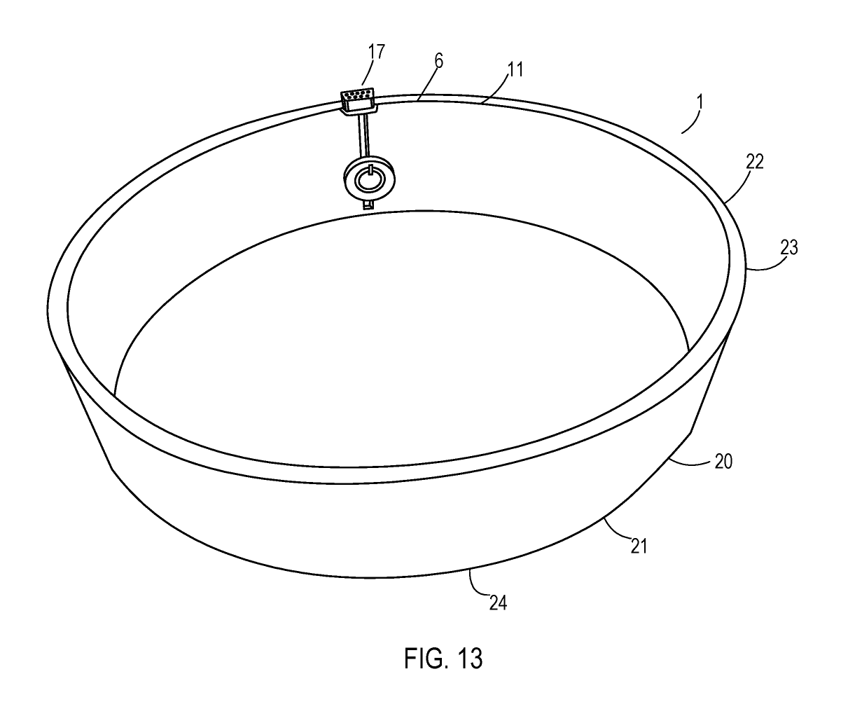

Exemplary headbands as shown in FIGS. 1-14 were prepared using various headband-forming steps. Specifications for some of the headbands are provided in the table below:

TABLE
Features/Specifications of Exemplary Headbands

| HeadNoise ™ Standard | HeadNoise ™ Fit |
|---|---|
| Bluetooth v4.2 or v5 (i.e., for use | Bluetooth v4.2 or v5 (i.e., for use |
| with phones or smart watches) | with phones or smart watches) |
| Battery life 4 hours | Battery life 6 hours |
| Water and sweat resistant IP 67 | Water and sweat resistant IP 67 |
| Microphone | Microphone |
| Rechargeable battery | Rechargeable battery |
| Bone conduction | Bone conduction |
| | Steps walked |
| | Steps climbed |
| | Measure distance traveled |
| | Calories burned |
| | Heart Rate sensor |
| | Skin Temperature |
| | Hydration levels |

As shown in the Table, the HeadNoise™ Fit headband provides all of the same features as the HeadNoise™ standard edition headband along with various other biometric sensors to track fitness. Although not shown in the figures, it should be understood that one or more biometric sensors to track fitness and detect other properties (as shown in the Table above) may be positioned along headband 1 in any manner so as to detect one or more of the properties shown in the Table above. For example, one or more biometric sensors may be positioned along (1) said inner headband surface 22; (2) an inner surface of headband support member 12, (3) housing member door 18, (4) an inner surface of housing member 19, or (5) any combination of (1) to (4).

Some headbands were formed using exemplary circuit board 40 shown in FIG. 14, wherein Bluetooth device 30 comprised a microcontroller unit/Bluetooth chip CSR8670, provided by Qualcomm (San Diego, Calif., USA), an amplifier 16 in the form of a general purpose transistor (i.e., chip BC857BLT1 provided by ON Semiconductor (Phoenix, Ariz., USA)) used in conjunction with 10 kiloOhm and 30 kiloOhm resistors to amplify sound 1:3, charging port 17, circuitry 14 extending all over circuit board 40, and accelerometer 37 in the form of a 3-axis chip MMA86S3FCR1 provided by NXP Semiconductors (Eindhoven, Netherlands).

It should be understood that although the above-described headbands and/or methods are described as “comprising” one or more components or steps, the above-described headbands and/or methods may “comprise,” “consists of,” or “consist essentially of” the above-described components, features or steps of the headbands and/or methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a headband and/or method that “comprises” a list of elements (e.g., components, features, or steps) is not necessarily limited to only those elements (or components or steps), but may include other elements (or components or steps) not expressly listed or inherent to the headband and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a headband and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described headbands and/or methods may comprise, consist essentially of, or consist of any of the herein-described components, features and steps, as shown in the figures with or without any feature(s) not shown in the figures. In other words, in some embodiments, the headbands and/or methods of the present invention do not have any additional features other than those shown in the figures, and such additional features, not shown in the figures, are specifically excluded from the headbands and/or methods. In other embodiments, the headbands and/or methods of the present invention do have one or more additional features that are not shown in the figures.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A headband comprising:
a tubular headband material having an outer headband surface, an inner headband surface, and opposite edges between said outer headband surface and said inner headband surface; and
one or more signal-accepting components incorporated in or attached to said tubular headband material, said one or more signal-accepting components being capable of receiving a wireless signal from a music-generating device and converting the wireless signal into music.

2. The headband of claim 1, wherein said one or more signal-accepting components comprises a Bluetooth device.

3. The headband of claim 2, further comprising two or more transducers connected to said one or more signal-accepting components.

4. The headband of claim 3, further comprising circuitry for processing said wireless signal.

5. The headband of claim 4, further comprising an amplifier.

6. The headband of claim 3, further comprising a headband support member that provides support for two or more transducers and said one or more signal-accepting components.

7. The headband of claim 1, further comprising a rechargeable battery.

8. The headband of claim 1, further comprising a USB Type-C charging port.

9. The headband of claim 5, wherein said Bluetooth device, said circuitry, said amplifier and said charging port are each positioned along a circuit board.

10. The headband of claim 9, further comprising an on/off switch.

11. The headband of claim 1, wherein said one or more signal-accepting components are attached to said inner headband surface of said tubular headband material.

12. The headband of claim 1, wherein said one or more signal-accepting components are incorporated within said tubular headband material.

13. The headband of claim 3, wherein said tubular headband material further comprises two or more openings within said inner headband surface of said tubular headband material, each opening being sized so that a given transducer can be positioned within and removed from said opening.

14. The headband of claim 1, wherein said tubular headband material is in the form of a continuous loop of material.

15. A method of using the headband of claim 1, said method comprising:
positioning the headband onto a user's head; and listening to music from the headband.

16. The method of claim 15, said method further comprising:
syncing the headband with a music-generating device.

17. A headband comprising:
a tubular headband material having an outer headband surface, an inner headband surface, and opposite edges between said outer headband surface and said inner headband surface;
one or more signal-accepting components incorporated in or attached to said tubular headband material, said one or more signal-accepting components being capable of receiving a wireless signal from a music-generating device and converting the wireless signal into music, said one or more signal-accepting components comprising a Bluetooth device;
two or more transducers connected to said one or more signal-accepting components;
circuitry for processing said wireless signal;
an amplifier;
a headband support member that provides support for said two or more transducers and said one or more signal-accepting components; and
an on/off switch.

18. The headband of claim 17, wherein said Bluetooth device, said circuitry, said amplifier and said charging port are each positioned along a circuit board.

19. The headband of claim 18, wherein said tubular headband material further comprises two or more openings within said inner headband surface of said tubular headband material, each opening being sized so that a given transducer can be positioned within and removed from said opening.

20. A method of using the headband of claim 19, said method comprising:
positioning the headband onto a user's head;
syncing the headband with a music-generating device; and
listening to music from the headband.
